(19) United States
(12) Patent Application Publication
(10) Pub. No.: US 2020/0111335 A1
(43) Pub. Date: Apr. 9, 2020

(54) INFRARED MOTION SENSING DEVICE AND METHOD

(71) Applicant: 9138-4529 QUÉBEC INC., Victoriaville (CA)

(72) Inventors: Yan GAGNON, Victoriaville (CA); Jérôme RANCOURT, Victoriaville (CA); François DION, Victoriaville (CA)

(73) Assignee: 9138-4529 QUÉBEC INC., Victoriaville, QC (CA)

(21) Appl. No.: 16/396,149

(22) Filed: Apr. 26, 2019

Related U.S. Application Data
(60) Provisional application No. 62/741,068, filed on Oct. 4, 2018.

(51) Int. Cl. G08B 13/191; G08B 13/196; G06K 9/00

(52) U.S. Cl. CPC G08B 13/191; G06K 9/00771; G08B 13/19636

(57) ABSTRACT

Techniques for detecting object motion within a monitored scene are disclosed. In an embodiment, an infrared motion sensing device can include an infrared detector configured to receive infrared radiation from the monitored scene within a detection field of view and to generate an output waveform signal indicative of time-dependent variations in the received infrared radiation in response to object motion within the detection field of view. The infrared motion sensing device can also include a processor configured to receive the output waveform signal generated by the infrared detector and perform a signal analysis based on the output waveform signal to determine whether a motion event has occurred, which can involve finding a match between the output waveform signal and the one or more reference waveform signals. Upon determination that a motion event has occurred, the processor can be controlled, for example, to trigger an image sensor to capture an image.

### CROSS-REFERENCE TO RELATED APPLICATIONS

The present application claims priority from U.S. Provisional Patent Application No. 62/741,068 filed on Oct. 4, 2018, the disclosure of which is incorporated by reference in its entirety.

### TECHNICAL FIELD

The technical field generally relates to radiation-based motion detection, and particularly, to infrared motion sensing devices and methods, for example for use in an autonomous surveillance camera using passive infrared (PIR) motion detection to provide improved detection of a subject in a detection range of the camera.

### BACKGROUND

Surveillance cameras are commonly used for capturing images of subjects in the context of hunting, general wildlife surveillance, security purposes or the like. In many cases, such a camera can be initially installed in a desired location where monitoring is desired, and be subsequently left unattended during extended surveillance time periods during which surveillance can be autonomously performed by the camera.

In many cases, especially in the fields of hunting and wildlife surveillance, the location where the camera is installed can be a remote location, such as a forest, a field, or the like. In such cases, surveillance cameras may have to operate autonomously for extended time periods during which the camera monitors the surroundings to detect the presence of a subject. Particularly, the camera may have to perform subject detection in a low-power operation mode while no subject is detected, and to trigger quickly to capture images of a subject upon detection of a subject within the field of view of the camera.

Surveillance cameras can use passive infrared (PIR) motion sensing devices for motion detection. A PIR motion sensing device is configured to measure infrared radiation emitted by or reflected from an object moving in its field of view and to convert the measured infrared radiation into an electrical signal that is representative of time variations in the measured infrared radiation and that conveys information about the motion of the object. A PIR motion sensing device can include a PIR sensor (e.g., a pyroelectric sensor) configured to generate an electrical signal when exposed to infrared radiation from a target area, collection optics (e.g., a Fresnel lens) configured to collect infrared radiation received from the target area and to direct the collected infrared radiation on the PIR sensor, and electronic circuitry configured to process the electrical signal received from the PIR sensor to detect object motion. Non-limiting examples of signal processing operations can include DC offset cancelation, signal amplification, filtering, comparison, analog-to-digital conversion, and any combination thereof. The output signal of the electronic circuitry is typically a binary signal indicative of whether or not a moving object has been detected within the detection range of the PIR motion sensing device. For example, some PIR motion sensing devices can segment the target area into multiple detection zones and monitor these detection zones to detect differences therebetween indicative of the presence of a moving object (e.g., when the amplitude of a detected difference, typically pre-amplified, matches or exceeds a certain detection threshold). Upon motion detection, the binary output signal generated by the PIR motion sensing device changes its logical state (e.g., changing from 0 to 1, or vice versa). The surveillance camera can include a processor configured to monitor the binary output signal generated by the PIR motion sensing device and, upon object motion detection, to trigger the image sensor to capture an image of the target area.

While conventional infrared motion sensing devices with binary output signals have certain advantages, they also have drawbacks and limitations. Examples of such drawbacks and limitations include suboptimal detection efficiency, limited object recognition capabilities, limited control over detection sensitivity, and high false detection rates. Consequently, challenges remain in the field of infrared motion sensing devices and related motion detection techniques.

### SUMMARY

The present description generally relates to techniques for object motion detection from waveform-based infrared sensor data.

In accordance with an aspect, there is provided an infrared motion sensing device for detecting object motion within a monitored scene. The infrared motion sensing device includes an infrared detector configured to receive infrared radiation from the monitored scene within a detection field of view and to generate an output waveform signal indicative of time-dependent variations in the received infrared radiation in response to object motion within the detection field of view. The infrared motion sensing device also includes a processor configured to receive the output waveform signal generated by the infrared detector and perform a signal analysis based on the output waveform signal to determine whether a motion event has occurred.

In an embodiment, the infrared motion sensing device includes one or more infrared sensors and collection optics optically coupled to the one or more infrared sensors to define the detection field of view, the collection optics being configured to collect the infrared radiation received from within the detection field of view and direct it to the one or more infrared sensors. In an embodiment, the one or more infrared sensors include a pair of passive infrared (PIR) pyroelectric sensors configured to produce electrical outputs of opposite polarities in response to infrared radiation exposure. In an embodiment, the collection optics includes a Fresnel lens including configured to create a plurality of detection zones within the detection field of view.

In an embodiment, the processor is configured to perform the signal analysis by assessing one or more waveform characteristics of the output waveform signal over an analysis period. For example, the one or more waveform characteristics can include an amplitude, a period, or a combination thereof.

In an embodiment, the infrared motion sensing device further includes a memory operatively coupled to the processor, wherein the memory is configured to store thereon one or more reference waveform signals, and wherein the processor is configured to determine that a motion event has occurred by finding a match between the output waveform signal and the one or more reference waveform signals.

In an embodiment, the processor is configured to perform the signal analysis by selecting between a lower sensitivity level and a higher sensitivity level for use in the signal analysis; if the lower sensitivity level is selected, comparing an amplitude parameter of the output waveform signal against an amplitude threshold, and determining that a motion event has occurred or not, based on whether or not the amplitude parameter matches or exceeds the amplitude threshold; and if the higher sensitivity level is selected, comparing an amplitude parameter of the output waveform signal against an amplitude threshold to make an initial assessment of whether a motion event has occurred or not, and depending on whether the initial assessment is positive or not, comparing the output waveform signal against either a first or a second reference waveform signal (e.g., stored in and retrieved from a database or a memory coupled to the processor) to make a further assessment of whether a motion event has occurred or not, wherein the first reference waveform signal has a smaller amplitude than the second reference waveform signal.

In an embodiment, the processor is configured to determine, from the signal analysis performed on the output waveform signal, one or more of object position information, object speed information, object direction of travel information, object size information, object shape information, and object type information about the motion event.

In an embodiment, the processor is configured to activate an output device in response to the processor determining that a motion event has occurred.

In accordance with another aspect, there is provided a method for detecting object motion within a monitored scene. The method includes receiving or measuring, for example by an infrared detector such as a PIR pyroelectric detector, radiation from the monitored scene within a detection field of view; generating, by a processor, an output waveform signal indicative of time-dependent variations in the received radiation in response to object motion within the detection field of view; and performing, by the processor, a signal analysis based on the output waveform signal to determine whether a motion event has occurred.

In an embodiment, the method further includes partitioning the detection field of view into a plurality of overlapping or non-overlapping detection zones. In an embodiment, partitioning the detection field of view includes providing the a PIR detector with a Fresnel lens configured to create the detection zones.

In an embodiment, performing the signal analysis includes assessing one or more waveform characteristics of the output waveform signal over an analysis period, for example an amplitude, a period, or a combination thereof.

In an embodiment, performing the signal analysis includes providing one or more reference waveform signals; and determining that a motion event has occurred by finding a match between the output waveform signal and the one or more reference waveform signals.

In an embodiment, performing the signal analysis includes selecting between a lower sensitivity level and a higher sensitivity level for use in the signal analysis; if the lower sensitivity level is selected, comparing an amplitude parameter of the output waveform signal against an amplitude threshold, and determining that a motion event has occurred or not, based on whether or not the amplitude parameter matches or exceeds the amplitude threshold; and if the higher sensitivity level is selected, comparing an amplitude parameter of the output waveform signal against an amplitude threshold to make an initial assessment of whether a motion event has occurred or not, and depending on whether the initial assessment is positive or not, comparing the output waveform signal against either a first or a second reference waveform signal to make a further assessment of whether a motion event has occurred or not, wherein the first reference waveform signal has a smaller amplitude than the second reference waveform signal.

In an embodiment, performing the signal analysis includes determining one or more of object position information, object speed information, object direction of travel information, object size information, and object type information about the motion event.

In an embodiment, the method further includes taking an action in response to determining that a motion event has occurred. The action taken can include activating, by the processor, an image sensor, a light source, an alarm, or a combination thereof.

In an embodiment, the radiation received from the scene includes infrared radiation, which can be detected by a PIR detector.

In accordance with another aspect, there is provided a non-transitory computer readable storage medium having stored thereon computer readable instructions that, when executed by a processor, cause the processor to perform a method for detecting object motion within a monitored scene. The method includes receiving, by the processor, an output waveform signal generated from infrared radiation received by an infrared detector from the monitored scene within a detection field of view, the output waveform signal being indicative of time-dependent variations in the received infrared radiation in response to object motion within the detection field of view; and performing, by the processor, a signal analysis based on the output waveform signal to determine that object motion has occurred. Performing the signal analysis can include one or more of the steps and features described above.

In an embodiment, the method further includes activating, by the processor, the infrared detector to initiate receiving the infrared radiation from the monitored scene within the detection field of view. In an embodiment, the method further includes taking an action in response to the processor determining that a motion event has occurred, wherein taking an action can include triggering, by the processor, an image sensor to capture an image, a light source to emit illumination light, an alarm to generate an alarm signal, or a combination thereof.

In accordance with another aspect, there is provided a computer device for detecting object motion within a monitored scene. The computer device includes a processor and a non-transitory computer readable storage medium as described herein operatively coupled to the processor.

In accordance with another aspect, there is provided a motion-detection-activated camera. The motion-detection-activated camera includes an image sensor for imaging a target area; an infrared detector configured to monitor the target area for object motion, the infrared detector receiving infrared radiation from the target area and generating an output waveform signal indicative of time-dependent variations in the received infrared radiation in response to motion of an object within the target area; and a processor operatively connected to the image sensor and the infrared detector, the processor being configured to receive the output waveform signal generated by the infrared detector, perform a signal analysis based on the output waveform signal to determine that object motion has occurred, and, in response to determining that object motion has occurred, control the image sensor to capture one or more images of the target area.

In an embodiment, the infrared detector includes one or more PIR pyroelectric sensors configured to sense the received infrared radiation and convert the received infrared radiation to yield the output waveform signal; and a Fresnel lens configured to collect the infrared radiation from the target area and to direct it to the one or more PIR pyroelectric sensors. In an embodiment, the one or more PIR pyroelectric sensors include a pair of PIR pyroelectric sensors configured to produce electrical outputs of opposite polarities in response to infrared radiation exposure.

In an embodiment, the processor is configured to perform the signal analysis by assessing one or more waveform characteristics of the output waveform signal. In an embodiment, the motion-detection-activated camera includes a memory operatively coupled to the processor, wherein the memory is configured to store thereon one or more reference waveform signals, and wherein the processor is configured to determine that a motion event has occurred by finding a match between the output waveform signal and the one or more reference waveform signals.

In accordance with another aspect, there is provided an infrared motion sensing digital camera. The camera includes a PIR-based subject detector; a control unit operatively connected to the PIR-based subject detector; and an image sensor operatively connected to a shutter mechanism and the control unit. The PIR-based subject detector is operative to monitor a presence of a subject within a field of view thereof. The PIR-based subject detector includes a PIR sensor measuring infrared light radiating from objects in detection zones of the field of view of the PIR-based subject detector and generating a waveform signal representative of differences on the measured infrared light between the detection zones of the PIR sensor. The control unit is configured to receive the waveform signal from the PIR sensor and perform signal analysis of the waveform signal from the PIR sensor to determine the occurrence of a triggering event. The image sensor and the shutter mechanism are selectively activated to perform image capture of the subject, upon the determination of the occurrence of a triggering event by the control unit.

In an embodiment, the PIR-based subject detector generates an output signal similar to the waveform signal from the PIR sensor. The control unit receives the output signal from the PIR-based subject detector and performs signal analysis of the output signal.

In an embodiment, the control unit is operatively connected to a data source storing at least one reference signal and the control unit is further configured to compare the waveform signal from the PIR sensor with the at least one reference signal to perform the signal analysis of the waveform signal from the PIR sensor to determine the occurrence of a triggering event.

In an embodiment, the at least one reference signal includes a first reference signal and a second reference signal stored in the data source. In an embodiment, the control unit is further configured to compare the waveform signal from the PIR sensor with the first reference signal following an initial analysis of the waveform signal from the PIR sensor non-indicative of the presence of a subject within the field of view of the PIR-based subject detector and to compare the waveform signal from the PIR sensor with the second reference signal following an initial analysis of the waveform signal from the PIR sensor indicative of the presence of a subject within the field of view of the PIR-based subject detector. In an embodiment, the first reference signal is a waveform signal having an amplitude and a wavelength of about 80% of the waveform signal from the PIR sensor having a maximal amplitude and wavelength. In an embodiment, the second reference signal is a waveform signal having an amplitude and a wavelength of about 50% of the waveform signal from the PIR sensor having a maximal amplitude and wavelength. In an embodiment, the control unit is further configured to compare the evolution of the waveform signal from the PIR sensor over a predetermined time period with the evolution of the at least one reference signal over the predetermined time period to perform the signal analysis of the waveform signal from the PIR sensor to determine the occurrence of a triggering event.

In accordance with another aspect, there is provided a method for capturing images by an infrared motion sensing digital camera. The method includes: monitoring a presence of a subject in a field of view of a PIR-based subject detector including a PIR sensor measuring infrared light radiating from objects in detection zones of the field of view of the PIR-based subject detector and generating a waveform signal representative of differences on the measured infrared light between the detection zones of the PIR sensor; receiving the waveform signal from the PIR sensor at a control unit; performing signal analysis of the waveform signal from the PIR sensor at the control unit to determine the occurrence of a triggering event; and performing image capture, upon the determination of the occurrence of a triggering event by the control unit.

In an embodiment, performing signal analysis of the waveform signal from the PIR sensor includes comparing the waveform signal from the PIR sensor with at least one reference signal. In an embodiment, performing signal analysis of the waveform signal from the PIR sensor includes performing an initial analysis of an amplitude of the waveform signal from the PIR sensor to determine whether the waveform signal from the PIR sensor is indicative or non-indicative of the presence of a subject within the field of view of the PIR-based subject detector. In an embodiment, comparing the waveform signal from the PIR sensor with at least one reference signal includes comparing the waveform signal from the PIR sensor with a first reference signal following the initial analysis of the waveform signal from the PIR sensor non-indicative of the presence of a subject within the field of view of the PIR-based subject detector and comparing the waveform signal from the PIR sensor with the second reference signal following an initial analysis of the waveform signal from the PIR sensor indicative of the presence of a subject within the field of view of the PIR-based subject detector. In an embodiment, the first reference signal is a waveform signal having an amplitude and a wavelength of about 80% of the waveform signal from the PIR sensor having a maximal amplitude and wavelength. In an embodiment, the second reference signal is a waveform signal having an amplitude and a wavelength of about 50% of the waveform signal from the PIR sensor having a maximal amplitude and wavelength. In an embodiment, comparing the waveform signal from the PIR sensor with at least one reference signal includes comparing the evolution of the waveform signal from the PIR sensor over a predetermined time period with the evolution of the at least one reference signal over the predetermined time period.

It is to be noted that other method and process steps may be performed prior, during or after the steps described herein. The order of one or more steps may also differ, and some of the steps may be omitted, repeated and/or combined, depending on the application.

Other objects, features, and advantages of the present description will become more apparent upon reading of the following non-restrictive description of specific embodiments thereof, given by way of example only with reference to the appended drawings. Although specific features described in the above summary and in the detailed description below may be described with respect to specific embodiments or aspects, it should be noted that these specific features can be combined with one another unless stated otherwise.

### BRIEF DESCRIPTION OF THE DRAWINGS

FIG. 1 is a front elevation view of a motion-detection-activated camera, in accordance with a possible embodiment, depicted in a closed configuration.

FIG. 2 is a front elevation view of the motion-detection-activated camera of FIG. 1, depicted in an open configuration.

FIG. 3 is a simplified block diagram of the motion-detection-activated camera of FIG. 1.

FIG. 4 is a schematic representation of the motion-detection-activated camera of FIG. 1. The motion-detection-activated camera is configured for initiating an image capture of a scene, upon determination of object motion in scene using PIR motion sensing.

FIG. 5 is a flow diagram of a method for detecting object motion within a monitored scene, in accordance with a possible embodiment.

FIG. 6 is a flow diagram of a method for detecting object motion within a monitored scene, in accordance with another possible embodiment.

FIG. 7 is a flow diagram of a method for detecting object motion within a monitored scene, in accordance with another possible embodiment.

FIG. 8 is a graph showing a first reference waveform signal and a second reference waveform signal used in the signal analysis step of a possible embodiment of a method for detecting object motion within a monitored scene.

FIG. 9 is a schematic representation of a PIR motion sensing device according to a possible embodiment, wherein the PIR motion sensing device is coupled to an image capture device.

FIG. 10 is a schematic representation of a PIR motion sensing device according to a possible embodiment, wherein the PIR motion sensing device is coupled to light source.

FIG. 11 is a schematic representation of a PIR motion sensing device according to a possible embodiment, wherein the PIR motion sensing device is coupled to an alarm device.

### DETAILED DESCRIPTION

In the present description, similar features in the drawings have been given similar reference numerals. To avoid cluttering certain figures, some elements may not be indicated if they were already identified in a preceding figure. It should also be understood that the elements of the drawings are not necessarily depicted to scale, since emphasis is placed on clearly illustrating the elements and structures of the present embodiments. Furthermore, positional descriptors indicating the location and/or orientation of one element with respect to another element are used herein for ease and clarity of description. Unless otherwise indicated, these positional descriptors should be taken in the context of the figures and should not be considered limiting. It will be understood that such spatially relative terms are intended to encompass different orientations in the use or operation of the present embodiments, in addition to the orientations exemplified in the figures.

Furthermore, the implementations, geometrical configurations, materials mentioned and/or dimensions shown in the figures or described in the present description are provided solely for exemplification purposes. Particularly, although embodiments of the PIR motion sensing device and the motion-detection-activated camera, and corresponding parts thereof, consist of certain configurations as explained and illustrated herein, not all of these components and configurations are essential and thus should not be taken in their restrictive sense. It is to be understood that other suitable components and configurations may be used in other variants.

Unless stated otherwise, the terms “connected”, “coupled”, and derivatives and variants thereof, refer to any connection or coupling, either direct or indirect, between two or more elements. The connection or coupling between the elements may be mechanical, optical, thermal, electrical, logical, or a combination thereof.

In the present description, the terms “a”, “an” and “one” are defined to mean “at least one”, that is, these terms do not exclude a plural number of items, unless stated otherwise.

Terms such as “substantially”, “generally” and “about”, that modify a value, condition or characteristic of a feature of an exemplary embodiment, should be understood to mean that the value, condition or characteristic is defined within tolerances that are acceptable for the proper operation of this exemplary embodiment for its intended application.

The terms “match”, “matching” and “matched” are intended to refer herein to a condition in which two elements are either the same or within some predetermined tolerance of each other. That is, these terms are meant to encompass not only “exactly” or “identically” matching the two elements but also “substantially”, “approximately” or “subjectively” matching the two elements, as well as providing a higher or best match among a plurality of matching possibilities.

The present description generally relates to techniques for monitoring and detecting object motion using waveform-based analysis of infrared sensor data, for example passive infrared (PIR) sensor data.

The present techniques may be useful in various motion detection applications and scenarios, in both indoor and outdoor environments. Non-limiting examples of application are hunting, wildlife and livestock monitoring, human identification, security and surveillance, lighting, traffic monitoring, and any applications that may require or benefit from object motion detection.

As described in greater detail below, the present description relates in one aspect to an infrared motion sensing device for detecting object motion within a monitored scene. The infrared motion sensing device generally includes an infrared detector and a processor. The infrared detector, which may include one or more PIR sensors, is configured to receive infrared radiation from the monitored scene within its field of view and detection range, and to generate an output waveform signal indicative of time-dependent variations in the received infrared radiation in response to object motion within the detection field of view. The processor is configured to receive the output waveform signal generated by the infrared detector and perform a signal analysis based on the output waveform signal to determine whether a motion event has occurred. In response to determining the occurrence of such a motion event, the processor may be configured to activate an output device, for example an image capture device, an illumination device, or an alarm, as the case may be. Other non-limiting aspects of the present description include a method for detecting object motion within a monitored scene; a non-transitory computer readable storage medium having stored thereon computer readable instructions that, when executed by a processor, cause the processor to perform a method for detecting object motion within a monitored scene; a computer device for detecting object motion within a monitored scene and including a processor and a non-transitory computer readable storage medium; and a motion-detection-activated camera including an image sensor, an infrared detector, and a processor.

In the present description, the term “object” is meant to refer broadly to any physical entity of interest, whose motion can be monitored or detected using the present techniques. The object can be a person, an animal, a vehicle, or any other animate (living) and inanimate (nonliving) detectable heat sources. In principle, the term “object” is not meant to be restricted with respect to size, shape, or color. It is to be noted that the term “subject” is used herein to refer to humans and non-human animals.

The term “scene” is meant to denote any region, space, volume, area, surface, environment, target, feature or information of interest which can be monitored for object motion according to the present techniques. Depending on the application, the monitored scene can be an indoor scene or an outdoor scene. In an embodiment, the monitored scene can be a wildlife scene (e.g., a forest or a field), although various other scenes can be monitored in other embodiments including, but not limited to, industrial, commercial, residential, healthcare, farming, and agricultural facilities, and the like.

The terms “light” and “optical”, and any variants and derivatives thereof, are intended to refer to electromagnetic radiation in any appropriate region of the electromagnetic spectrum, and they are not limited to visible light. By way of example, in some embodiments, the terms “light” and “optical” may encompass electromagnetic radiation with a wavelength ranging from about 0.7 μm to 15 μm, encompassing infrared radiation. Particularly, although some implementations of the present techniques can be useful in infrared applications, other embodiments could additionally or alternatively operate in other regions of the electromagnetic spectrum, for example in the terahertz regions.

Infrared radiation is commonly divided into various regions including the near-infrared (NIR) region for wavelengths ranging from 0.7 μm and 1.4 μm; the short-wavelength infrared (SWIR) region for wavelengths ranging from 1.4 μm to 2.5 μm or 3 μm; the mid-wavelength infrared (MWIR) region for wavelengths ranging from 2.5 μm or 3 μm to 8 μm; and the long-wavelength infrared (LWIR) region for wavelengths ranging from 8 μm to 15 μm. In this regard, the skilled person will appreciate that the definitions of different infrared regions in terms of spectral ranges, as well as the dividing lines between them, can vary depending on the technical field under consideration, and are not meant to limit the scope of applications of the present techniques.

The term “passive infrared”, or its acronym “PIR”, refers to an infrared sensor or detector that measures infrared radiation emanating from within its field of view passively, that is, without emitting radiation of its own. PIR detectors are commonly used in motion sensors, where they detect object motion by sensing variations in received infrared radiation that occur when objects (i.e., heat sources) move within their field of view. Upon detection motion, PIR detectors generate an electrical signal that can be used to trigger, activate or otherwise control another device, for example, an image capture device, a lighting device, or an alarm device.

Various implementations of the present techniques are described below with reference to the figures.

### Motion-Detection-Activated Camera Implementations

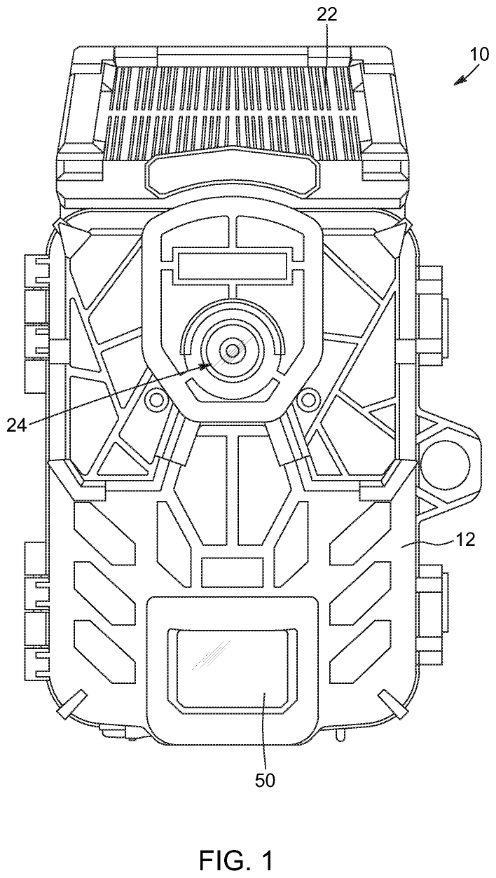

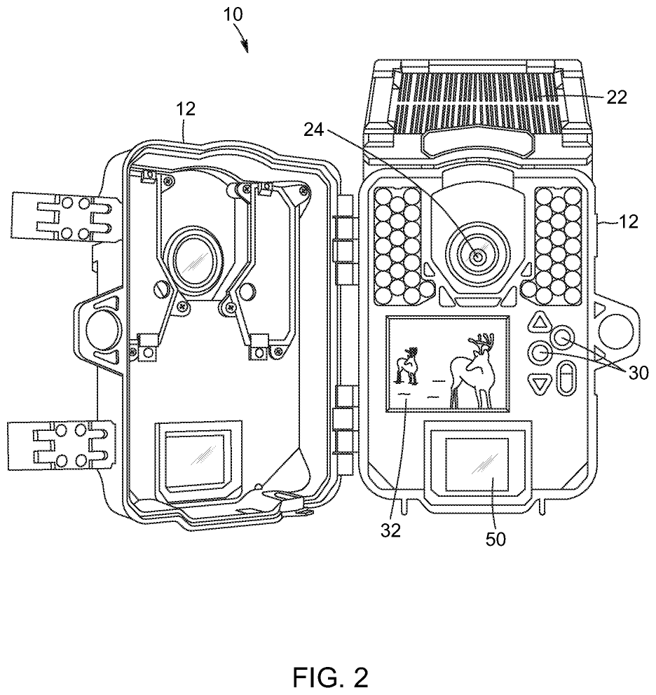

Referring generally to FIGS. 1 to 4, there is illustrated a possible embodiment of a motion-detection-activated camera 10, which can be used as an autonomous infrared motion sensing digital camera. In some implementations, the camera 10 can be used for capturing images of objects (e.g., people, animals, inanimate objects) in the context of hunting, general wildlife surveillance, security purposes, and the like. As illustrated in FIGS. 1 and 2, which respectively depicts the camera in a closed and an open configuration, the camera 10 generally includes a protective casing 12. The protective casing 12 defines the overall shape of the camera 10 and is configured to receive and protect its internal components, some of which are described in greater detail below. In an embodiment, the protective casing 12 is made of plastic, such as acrylic. However, in alternative embodiments, the protective casing 12 can be made of other materials, such as metals and composite materials, that are sufficiently rigid and durable to provide protection to the internal components against environmental elements. In an embodiment, when in the closed configuration (FIG. 1), the protective casing 12 can be substantially sealed to shield the internal components of the camera 10 against water, wind, dust, other contaminants, animal intrusion, and the like.

Returning to FIGS. 1 to 4, the camera 10 also includes internal components, which are components located at least partially inside the protective casing 12. In the illustrated embodiment, these internal components cooperate to allow, inter alia, the camera 10 to perform autonomous image capture (e.g., still images and/or videos) of a subject, such as a wildlife subject. In an embodiment, the internal components can include, without being limited to, a PIR-based subject detector 50; a control and processing unit 40 including a processor 36 and a memory 47; an image sensor 42; a camera lens 24; a shutter mechanism 43; a power unit 20; and a photovoltaic module 19. One skilled in the art will understand that further internal components commonly found in cameras can also be included in the camera 10. Non-limiting examples of such components include user inputs 30 (e.g., control buttons, touchscreens, and the like) and user outputs 32 (e.g., display screens, lights, and the like) to allow user interaction with the camera 10.

The PIR-based subject detector 50, or simply PIR detector, is operative to monitor the presence of a subject 14 within a monitored scene 16 extending in a certain perimeter or range around the camera 10. The PIR detector 50 is configured to cooperate with other internal components of the camera 10 to perform image capture of a subject, when and/or while the subject is detected within a detection field of view 18 of the PIR detector 50. In operation, the PIR detector 50 is configured to receive infrared radiation 26 from the monitored scene 16 within its detection field of view 18 and to generate an output waveform signal 52 indicative of time-dependent variations in the received infrared radiation 26 in response to object motion within the detection field of view 18.

The PIR detector 50 can include one or more PIR sensors 51 and collection optics 55 optically coupled to the one or more PIR sensors 51. The collection optics 55 define the detection field of view 18 of the PIR detector 50. The collection optics 55 are disposed in front of the PIR sensors 51 and configured to collect the received infrared radiation 26 and direct it to the one or more PIR sensors 51.

The PIR sensors 51 are configured detect changes in infrared radiation 26 from the monitored scene, for example due to object motion. The PIR sensors 51 can include a material or structure configured to produce an electrical signal when exposed to infrared radiation 26. Various types of PIR sensors exist and can be used depending on the application. In an embodiment, the PIR sensors 51 can be pyroelectric sensors, a type of thermal detectors commonly used in motion detection applications. A non-limiting example of a commercially available a pyroelectric sensor the PYD 1598 DigiPyro® IR pyroelectric detector manufactured by Excelitas Technologies. Pyroelectric detectors generally include a crystal of pyroelectric material placed between two electrodes. Upon exposure to infrared radiation 26, the temperature of the crystal changes and induces a corresponding change in its electric polarization. The change of polarization, in turn, is detected as an electrical signal in the circuit containing the electrodes. Pyroelectric detectors are generally known in the art, and need not be described in greater detail herein. However, although pyroelectric detectors may be prevalent in infrared motion detection applications, the present techniques are not restricted to pyroelectric sensors, but can use other types of PIR detection technologies. Non-limiting examples include other types of thermal detectors (e.g., thermoelectric devices such as thermocouples, thermopiles, thermistors and bolometers) and quantum detectors (e.g., photoconductive and photovoltaic devices). Furthermore, in other embodiments, active infrared detectors may also be used to implement the present techniques.

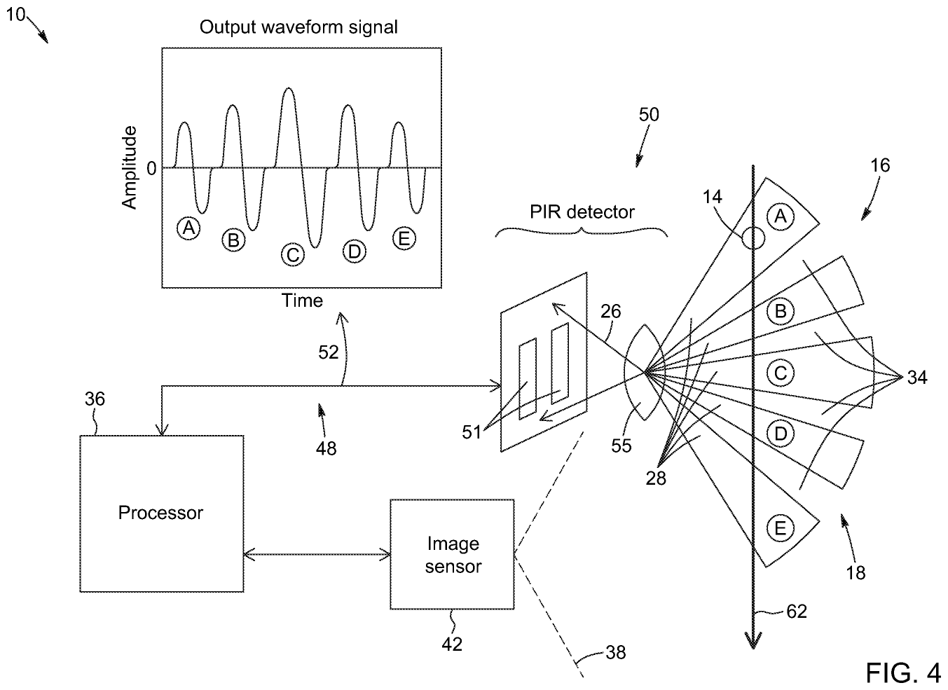

Depending on the application, the PIR detector 50 can include a single or multiple PIR sensors 51. For example, in the illustrated embodiment, the PIR detector 50 includes a pair of PIR sensors 51 configured to produce electrical outputs of opposite polarities when exposed to infrared radiation 26, corresponding to a differential detection scheme. It should be noted that the general principles underlying differential detection in PIR motion sensing are known in the art, and need be described in greater detail herein. While a single pair of PIR sensors 51 is depicted in FIG. 4, other implementations can include an array of PIR sensor pairs. Furthermore, other detection schemes can be used besides a differential detection, for example a quad-type detection scheme, in which the PIR detector includes one or multiple sets of four electrically connected PIR sensors.

The collection optics 55 can include various types of refractive (e.g., lenses) and reflective (e.g., mirrors) optical components. Depending on the application, the collection optics 55 can include a single or multiple optical axes. In multi-axis implementations, the collection optics 55 divide the detection field of view 18 into a plurality of detection zones 28, as depicted in FIG. 4. The provision of the collection optics 55 can increase the detection area of the PIR sensors 51. It should be noted that some embodiments of the present techniques may not include collection optics.

In the illustrated embodiment, the collection optics 55 include a Fresnel lens including many Fresnel lenslets and configured to define a plurality of detection zones 28 within the detection field of view 18. In this example, the Fresnel lens creates five detection zones 28, spaced apart from one another by non-detection zones 34, or dead zones, which are not imaged by the PIR detector 50. However, depending on the application, various Fresnel lens configurations can be used to control the number, size, shape, spacing, orientation, and/or arrangement of the detection and non-detection zones. In an embodiment, the size and shape of the Fresnel lens and its positioning relative to the PIR sensors 51 may be configured to minimize or at least reduce the space between the detection zones 28 (i.e., the size of the non-detection zones 34), without or with reduced impact on the angular extent of the detection field of view 18 of the PIR detector 50. It should be understood that, while the detection zones 28 and the non-detection zones 34 appear as two-dimensional regions in the schematic representation of FIG. 4, they are in fact three-dimensional regions It should also be noted that Fresnel lenses and their use in PIR motion detection applications are generally known in the art, and need not be described in greater detail herein.

In FIG. 4, the image of each detection zone 28 is projected by the Fresnel lens on both PIR sensors 51, which, as noted above, implement a differential detection scheme. In this configuration, when a subject 14 passes successively through the five detection zones 28, the output waveform signal 52 generated by the PIR detector 50 as a function of time may look like the one depicted in FIG. 4. This can be understood as follows. Upon crossing one of the detection zones 28, the subject 14 produces a first differential output when its image falls predominantly on one of the PIR sensors 51, and a second differential output when its image falls predominantly on the other one of the PIR sensors 51. In a differential detection scheme, the first and second differential outputs are of opposite polarities. Therefore, after the subject 14 has passed through the five detection zones 28 (labeled A to E) along an subject motion path 62, the output waveform signal 52 generated by the PIR detector 50 will feature a succession of alternating positive and negative output regions (also labeled A to E), when the image of the subject 14 falls predominantly on either one of the PIR sensors 51, interspersed by zero or near-zero output regions, when the image of the subject 14 falls equally on or entirely between the PIR sensors 51, or when the subject 14 passes through one of the non-detection zones. In general, the temporal profile of the output waveform signal 52 generated by the PIR detector 50 may depend on various parameters. Non-limiting examples of such parameters include the size, speed, acceleration, distance, and direction of travel of the subject 14; the spatial configuration of the detection and non-detection zones 28, 34 generated by the collection optics 55 (e.g., Fresnel lens); the number, size and positioning of the PIR sensors 50; and any combination thereof.

In contrast to conventional PIR detectors configured to generate a binary signal having either a first or true value, indicative that object motion has been detected, or a second or false value, indicative that no object motion has been detected, the output of the PIR detector 50 in FIGS. 1 to 4 is a waveform signal in the time domain, that is, a time series of data. Particularly, the output waveform signal 52 has a time-dependent amplitude profile, which is representative of the instantaneous amount of infrared radiation 26 received by the PIR detector 50 over a finite time interval. As the case may be, the output waveform signal 52 may have a plurality of peaks and valleys, which may define one or more pulses or cycles. The peaks and valleys making up the output waveform signal 52 may be the same or may differ in any or all of amplitude, duration, shape, slope, width, height, polarity, and the like. The output waveform signal 52 may be periodic, nearly periodic, or aperiodic.

Depending on the application, the output waveform signal 52 can be an analog waveform signal, a digital waveform signal, or a combination thereof. In an embodiment, the output waveform signal 52 can be the raw or analog electrical signal produced by the PIR sensors 51 as a function of time during a measurement time interval, due to time-dependent variations in the received infrared radiation responsive to object's movement in the detection field of view 18 of the PIR detector 50. The analog electrical signal produced by the PIR sensors 51 can be a voltage output, a current output, or an electrical charge output, as the case may be. In another embodiment, the output waveform signal 52 can be based on or be representative of the analog electrical output of the PIR sensors 51.

In some implementations, the analog output of the PIR sensors 51 can be processed (e.g., amplified, filtered, converted from analog to digital format) by other components of the PIR detector 50 prior to being generated as the output waveform signal 52 and sent to the processor 36 for motion detection analysis. In such implementations, the output waveform signal 52 generated the PIR detector 50 retains the waveform features of the analog output of the PIR sensors 51. For example, in an embodiment, the analog output of the PIR sensors 51 can be converted into a digital waveform signal and be generated as such as the output waveform signal 52. In such a case, the digital output waveform signal 52 can be similar to or even practically undistinguishable from the original analog waveform output measured by the PIR sensors 51.

In other implementations, the analog output of the PIR sensors 51 can be converted between the time domain into the spectral domain prior to being output by the PIR detector 50. In such a case, the output waveform signal 52 is a frequency spectrum waveform signal, yet remains of a waveform-type and retains the information about the time-based waveform features contained in the analog output of the PIR sensors 51. In an embodiment, the PIR detector 50 can include appropriate circuitry and/or electronics to allow processing of the analog electrical output of the PIR sensors 51 for generating the output waveform signal 52.

In yet other implementations, the present techniques may be used with a PIR detector 50 configured to produce, in its intended operation mode (e.g., as intended by its manufacturer), an output signal which is not a waveform-type signal. For example, the intended output signal can be a binary signal indicative of whether or not a motion of an object has been detected. In such a case, the non-waveform-type output signal intended for use by the manufacturer is not sent to the processor 36 for motion detection analysis according to the present techniques. Rather, the PIR detector 50 may be reconfigured, bypassed or otherwise adapted such that the output signal 52 that is actually sent to the processor 36 for motion detection analysis is, or is based on, the analog electrical signal produced by the PIR sensors 51. In doing so, the output signal 52 generated by the PIR detector 50 and sent to the processor 36 for implementing the present techniques is, indeed, an “output waveform signal” as defined above.

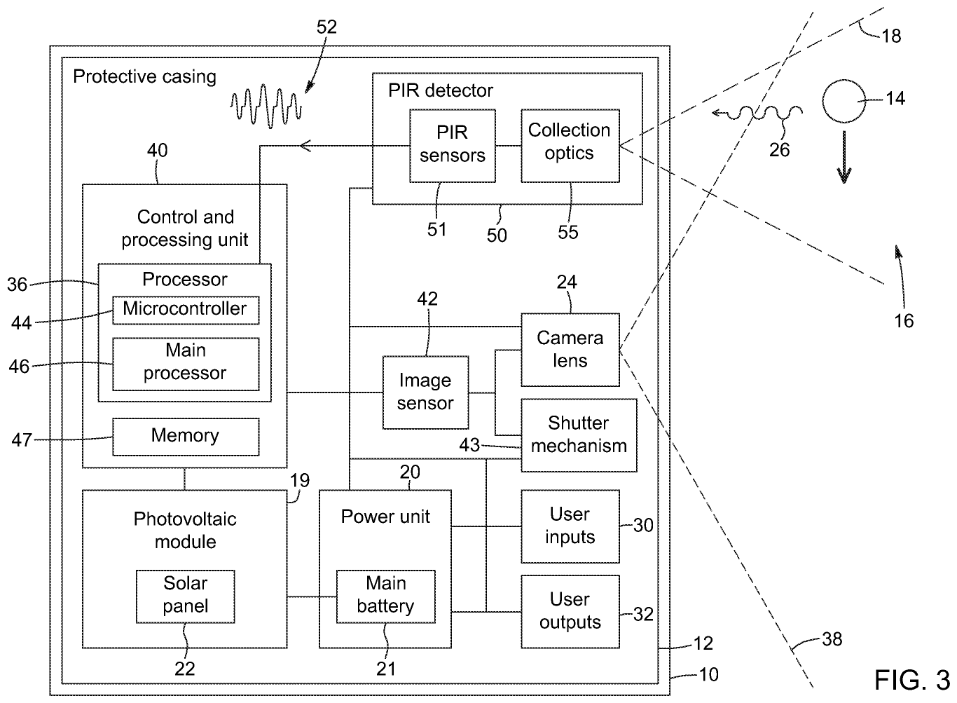

Referring to FIG. 3, the control and processing unit 40 refers to an entity of the camera 10 that control and executes, at least partially, the functions to operate and communicate with the various components of the camera 10 including, but not limited to, the PIR detector 50, the image sensor 42, the camera lens 24, the shutter mechanism 43, the user inputs 30, the user outputs 32, the power unit 20, and the photovoltaic module 19, and any subcomponents thereof. In some instances, the control and processing unit 40 can also be referred to as a “control unit” or a “computer device”. In the illustrated embodiment, the control and processing unit 40 generally includes a processor 36 and a memory 47.

The control and processing unit 40 can be provided within one or more general purpose computers and/or within any other suitable computing devices, implemented in hardware, software, firmware, or any combination thereof, and connected to various components of the camera 10 via appropriate wired and/or wireless communication links and ports. As the case may be, the control and processing unit 40 may be integrated, partially integrated, or physically separate from the optical hardware of the camera 10, including, but not limited to, the PIR detector 50 and the image sensor 42.

The processor 36 may implement operating systems, and may be able to execute computer programs, also generally known as commands, instructions, functions, processes, software codes, executables, applications, and the like. It is noted that term “computer program” is used in a generic sense to refer to any type of computer code (e.g. software or microcode) that can be employed to program the processor 36.

The processor 36 can be configured to receive the output waveform signal 52 generated by the PIR detector 50 and perform a signal analysis based on the output waveform signal 52 to determine whether a motion event—that is, a detection of a moving object—has occurred within the detection field of view 18 of the PIR detector 50. The processor 36 can be operatively connected to the PIR detector 50, using any suitable communication components, technologies and/or methods. More detail regarding various possible implementations of the motion event detection according to the present techniques will be provided below.

Depending on the application, the processor 36 may include a single processing entity or a plurality of processing entities. Such processing entities may be physically located within the same device, or the processor 36 may represent processing functionality of a plurality of devices operating in coordination. Accordingly, the processor 36 may include or be part of one or more of a computer; a microprocessor; a microcontroller; a coprocessor; a central processing unit (CPU); an image signal processor (ISP); a digital signal processor (DSP) running on a system on a chip (SoC); a dedicated graphics processing unit (GPU); a special-purpose programmable logic device embodied in a hardware device such as, for example, a field-programmable gate array (FPGA) or an application-specific integrated circuit (ASIC); a digital processor; an analog processor; a digital circuit designed to process information; an analog circuit designed to process information; a state machine; and/or other mechanisms configured to electronically process information and to operate collectively as a processor. Particularly, the terms “processor” and “controller” should not be construed as being limited to a single processor or a single controller, and accordingly, any known processor or controller architecture may be used.

The control and processing unit 40 may include or be coupled to a memory 47 capable of storing computer programs and other data to be retrieved by the processor 36. Depending on the application, the memory 47 can include one or more memory elements. In some instances, the memory 47 can also be referred to as a “computer readable storage medium”.

For example, in FIG. 3, the processor 36 includes a microcontroller 44 operative to provide general control functions for detecting a subject 14 within the detection field of view 18 of the PIR detector 50, and for operating the surveillance camera 10. In the illustrated embodiment, the processor 36 also includes a main processor 46 operatively connected to the microcontroller 44 using appropriate communication components, technologies and/or methods and operative to provide advanced control functions and process data relative to the capture of images by the image sensor 42. The main processor 46 may be connected to necessary firmware and/or peripherals, such as, for example, the memory 47, on which can be stored the instructions for providing the advanced control functions. It is appreciated that, in alternative embodiments, the control and processing unit 40 can include other components, different from those illustrated in FIG. 3. For example, in a non-limiting embodiment, the control and processing unit 40 may include a single control chip (e.g., a single microcontroller and/or a single microprocessor with suitable firmware and/or peripherals, or the like) or more than two control chips operatively connected to one another and/or to suitable firmware and/or peripherals.

Referring still to FIG. 3, the image sensor 42 can be embodied by any device or combination of devices capable of capturing an image of the monitored scene 16. The term “image sensor” refers generally to a device made up of a plurality of photosensitive elements (pixels) capable to detect electromagnetic radiation incident thereon from scene, and to generate an image of the scene, typically by converting the detected radiation into electrical data. Depending on the application, different types of image sensors can be used including, without limitation, charge-coupled device (CCD) and complementary metal-oxide-semiconductor (CMOS) sensors, but other types of image sensors (e.g., charge injection devices or photodiode arrays) could alternatively be used. The image sensor 42 can be a high-resolution digital image sensor, although a lower resolution image sensor can also be used. Both color and monochrome imager sensors can be used, as the case may be.

In the illustrated embodiment, the image sensor 42 has an imaging field of view 38 which at least partially overlap the detection field of view 18 of the PIR detector 50, so that the image sensor 42 may acquire an image of a subject 14 quickly upon detection of the subject 14 in the detection field of view 18 of the PIR detector 50. The image sensor 42 can operate in combination with a camera lens 24 (e.g., an objective) configured for focusing light toward the image sensor 42, and a shutter mechanism 43 configured to selectively allow or prevent light from reaching the image sensor 42.

In the illustrated embodiment, the power unit 20 provides the power required for powering various components of the camera 10. In an embodiment, the power unit 20 includes a main battery 21 operatively connected to a photovoltaic module 19 including a solar panel 22. The photovoltaic module 19 is configured to recharge the main battery 21, which can allow the camera 10 to operate during extended time periods, without requiring input of outside electrical power. As can appreciated, several types and models of photovoltaic modules and solar panels are known in the art and can be used to recharge the main battery 21. In another embodiment, no photovoltaic module 19 may be provided. It should be noted that depending on the application, various power management techniques can be implemented by the control and processing unit 40 to prolong battery life and optimize or improve camera performance, which can be useful for cameras operating in remote locations. Non-examples of power management techniques in autonomous motion-detection activated surveillance cameras are described in co-assigned U.S. Pat. Appl. Pub. No. 2018/0041736 A1, the disclosure of which is incorporated herein by reference in its entirety.

### Method Implementations

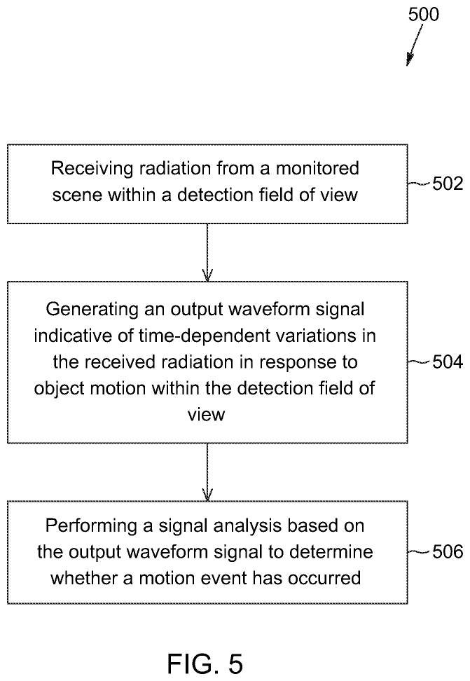

Referring now to FIG. 5, there is provided a flow diagram of a possible embodiment of a method 500 for detecting object motion within a monitored scene.

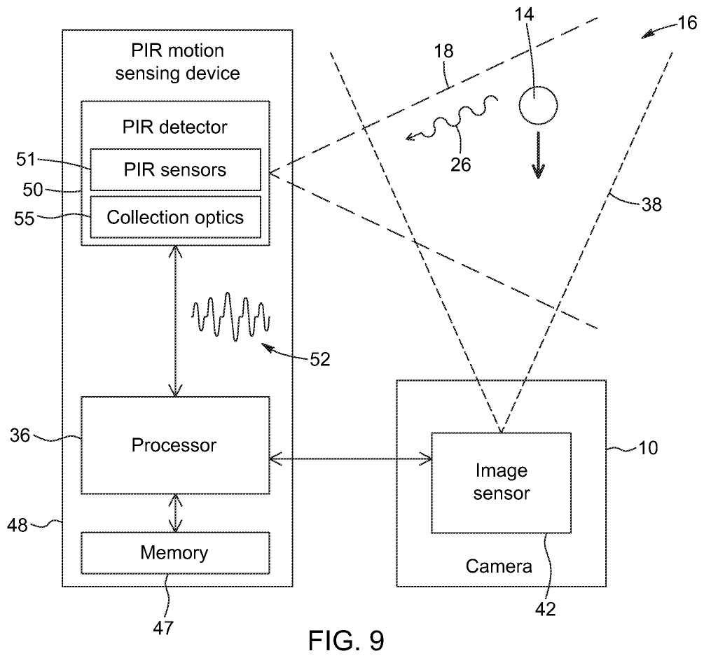

The method 500 includes a step 502 of receiving or measuring radiation (e.g., infrared radiation received or measured by a PIR detector) from the monitored scene within a detection field of view, and a step 504 of generating, by a processor, an output waveform signal indicative of time-dependent variations in the received radiation in response to object motion within the detection field of view. These steps can be performed as previously described, using an infrared motion sensing device 48 including a PIR detector 50 and a processor 36, such as illustrated in FIGS. 1 to 4 (see also FIGS. 9 to 11 described below), or another appropriate radiation-based motion sensing device.

The method 500 further includes a step 506 of performing, by the processor, a signal analysis based on the output waveform signal to determine whether a motion event has occurred. In some implementations, the spectral analysis performed by the processor can involve identifying or extracting, from the output waveform signal, one or more waveform characteristics, features or signatures that can convey information about the presence or the absence of an object in the detection field of view of the detector over an analysis period. In an embodiment, the waveform characteristics include an amplitude, a period, or a combination thereof. In general, the amplitude and period of the output waveform signal may convey information about, respectively, the size and the speed of an object within the detection field of view of the detector. However, in other embodiments, other or further waveform characteristics can be assessed. Non-limiting examples include a polarity, a range, a profile parameter (e.g., an envelope amplitude evolution in time, a pulse number, a pulse separation), a peak or valley parameter (e.g., position, shape, width, height, rise time, fall time, polarity, and the like), a noise parameter, and any combination thereof. Furthermore, the spectral analysis of the output waveform signal can be performed in the time domain, the frequency domain, or both, as the case may be.

In some implementations, the step 506 of performing the spectral analysis can involve providing one or more reference waveform signals. In an embodiment, the one or more reference waveform signals can be provided by accessing a virtual library or database having stored thereon one or more reference waveform signals associated with one or more corresponding motion event types or signatures. Depending on the application, the library or database can be located on a local memory system, a cloud, a server, or a peer-to-peer structure or network. For example, each reference waveform signal may be stored as a time series array of data or numbers that represent the expected infrared signature as a function of time of particular object motion within the detection field of view of the detector. Depending on the application, the reference waveform signals can be obtained from calibration, experimental data, analytical, numerical or empirical calculations or models, or a combination thereof. In some implementations, machine learning and training techniques may be used, at least in part, to obtain reference waveform signals. Furthermore, each reference waveform signal can contain information about a number of motion event parameters including, but not limited to, a position, a speed, an acceleration, a direction of travel information, a size, a shape, and a type of an object. Particularly, object type information can allow the spectral analysis to distinguish between a motion event caused by a human and motion event caused by an animal, and/or to assign different types of motion events to different types of animals.

The spectral analysis step 506 can further involve determining that a motion event has occurred by finding a match between the output waveform signal and any of the one or more reference waveform signals. As noted above, the terms “match”, “matching” and “matched” are meant to encompass not only an exact or identical match or concordance between the output waveform signal received from the detector and the one or more reference waveform signal stored in memory, but also a substantial, approximate, sufficient, or subjective match, as well as a higher or best match among a plurality of matching possibilities. Various matching criteria and thresholds can be used, as will be appreciated by one skilled in the art. For example, the output waveform signal may be either the same or within some predetermined tolerance of a given reference waveform signal, for example within a five to ten percent error with respect to one or more waveform parameters. In some applications, it may suffice that the general profile of a given reference waveform signal be present in the output waveform signal in order to find a suitable match. Furthermore, the present techniques also contemplate not only scenarios where the match between the output waveform signal and a reference waveform signal is absolute, but also scenarios where the match is relative (e.g., in terms of normalized spectra). In some implementations, in addition to determining that a motion event has occurred, the method 500 can allow further information to be obtained from the one of more reference waveform signals. Such information can include any or all of object position information, object speed information, object direction of travel information, object size information, object shape information, and object type information.

Various computer-implemented and software-based analytical or numerical tools and techniques may be employed to detect object motion by finding a match between the output waveform signal and the one or more reference waveform signals. Such tools and techniques may use matching algorithms based on feature extraction and pattern recognition, and may rely on machine learning and/or artificial intelligence.

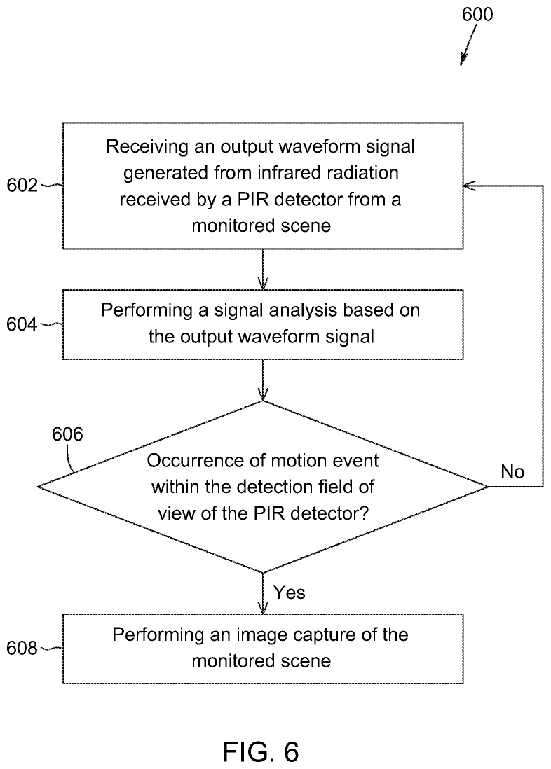

Referring to FIG. 6, there is illustrated another embodiment of a method 600 for detecting object motion within a monitored scene and, upon object motion detection, capturing an image of the monitored scene. The method can be performed using a motion-detection-activated camera 10, such as the one illustrated in FIGS. 1 to 4, or another appropriate motion-detection-activated camera.

The method 600 includes a step 602 of receiving, by a processor or controller (e.g., the microcontroller 44 in the embodiment of FIG. 3), an output waveform signal generated from infrared radiation received by a PIR detector from the monitored scene within a detection field of view. The output waveform signal is indicative of time-dependent variations in the received infrared radiation in response to object motion within the detection field of view.

In the present description, the phrase “receiving . . . an output waveform generated from infrared radiation received by a PIR detector” is used broadly so as to encompass, without being limited to, acquiring, making available for use, obtaining, measuring, recording, accessing, supplying, and retrieving the output waveform signal. By way of example, in some implementations, receiving the output waveform signal can involve the act of directly measuring the output waveform signal a PIR detector, such as described above, and making available the measured data to the processor. However, in other implementations, receiving the output waveform signal can involve the act of retrieving previously acquired experimental data, for example from a database or a storage medium.

The step 602 of receiving the output waveform signal can be performed repeatedly as a function of time to monitor the scene of an extended time interval. For example, a new output waveform signal can be received by the processor every second. It is appreciated that in such a case, the length of the waveform time series corresponding to each received output waveform signal would be equal to one second or less. As can appreciated, the receiving rate and the waveform length of the output waveform signal can vary in other embodiments.

The method 600 also includes a step 604 of performing, by the processor, a signal analysis based on the output waveform signal, followed by a step 606 of determining whether or not a motion event has occurred within the detection field of view of the PIR detector. This step can be performed as previously described.

In response to a determination that a motion event has occurred, the method 600 includes a step 608 of controlling or triggering a camera or an image capture device (e.g., including an image sensor and a shutter mechanism; see FIG. 3) to initiate performing an image capture of the monitored scene. In such implementations, since the occurrence of object motion triggers an image capture, the term “motion event” may also be referred to as a “triggering event”.

In the present description, the term “image capture” is used to define the capture of at least one image of a subject or object within the imaging field of view of an image capture device. The captured images can include still images, video images, or a combination thereof. Particularly, the at least one captured images can include any or all of a single still images, a sequence of multiple still images, a single video stream, or a sequence of multiple video streams. In an embodiment, a camera can include an instant picture mode, in which a capture of successive images is initiated upon detection of a motion event and is continued for as long object motion is detected (e.g., for as long as the object or subject remains detectable by the PIR detector). For example, the images can be acquired at rate of between one image per second and three images per second, although other acquisition rates can be used in other variants. In another embodiment, a camera can also or alternatively include a multi-picture mode, in which a preset number of still images are captured upon detection of a motion event. For example, the set of still images can include six images, which can be acquired at a rate of one image every five seconds. As can be appreciated, the number of still images and the rate at which they are acquired can be varied in other variants.

In an embodiment, following the capture of an image by the image sensor of the camera, a processor of the camera (e.g., the main processor 46 in the embodiment of FIG. 3) can receive the captured image data from the image sensor and process the image data to enhance, improve or otherwise alter image quality. In an embodiment, the processed image data can be stored on an image storage peripheral, for example an external memory card removably connectable to the camera, which can be subsequently retrieved by a user. In an embodiment, the camera may be configured to continuously store new captured images. Thus, should the image storage peripheral become full, the camera may be configured to overwrite previously recorded images with newly captured images. This process can ensure that the most recent captured images are stored on the image storage peripheral, albeit at the expense of overwriting older images.

After the image capture process has been initiated or completed, the method 600 may or may not, as the case may be, return to the step 602 of receiving an output waveform signal to continue monitoring the scene for object motion. As can be appreciated, following an image capture sequence, the processor or controller may be configured to resume repeatedly receiving 602 the output waveform signal generated by the PIR detector and performing 604 a signal analysis on the received output waveform signal until a further motion event is detected and triggers a further image capture.

In contrast, in response to a determination that object motion has not occurred, the method 600 may or may not, as the case may be, return to the step 602 of receiving an output waveform signal to continue monitoring the scene for object motion.

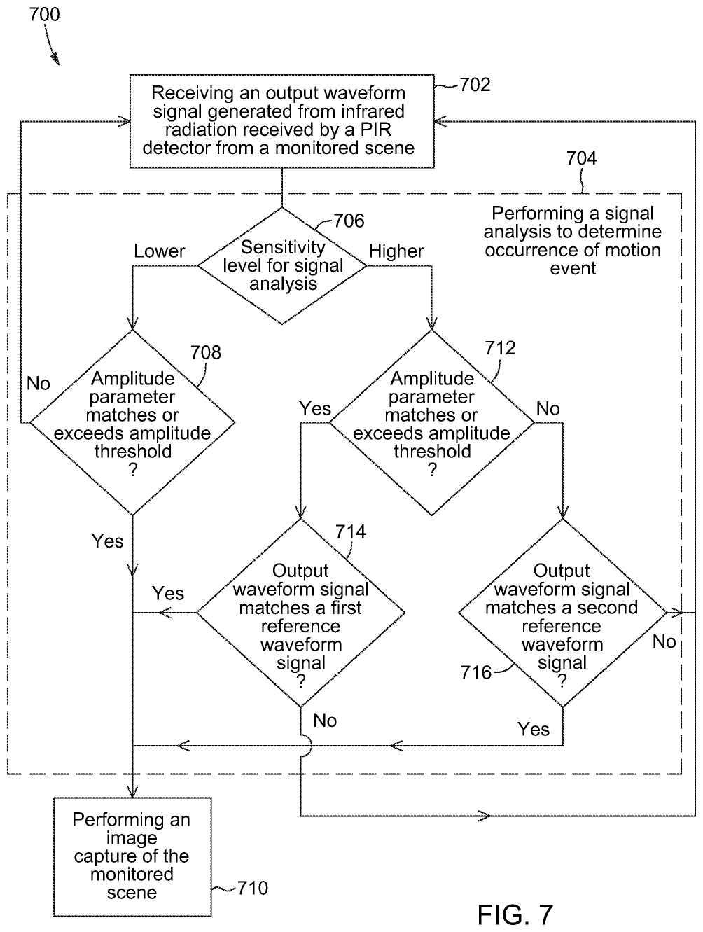

Referring to FIG. 7, there is illustrated another embodiment of a possible embodiment of a method 700 for detecting object motion within a monitored scene and, upon object motion detection, capturing an image of the monitored scene. In this embodiment, the signal analysis of the output waveform signal involves different steps depending on a user-selected or automatically selected sensitivity level with which to perform the analysis. The method can be performed using a motion-detection-activated camera 10, such as the one illustrated in FIGS. 1 to 4, or another appropriate motion-detection-activated camera.

The method 700 includes a step 702 of receiving an output waveform signal generated from infrared radiation received by a PIR detector from the monitored scene within a detection field of view. The output waveform signal is indicative of time-dependent variations in the received infrared radiation in response to object motion within the detection field of view. This step can be performed as previously described and, particularly, may include repeatedly receiving (e.g., every second) an output waveform signal from an PIR detector as a function of time to monitor the scene of an extended time interval.

The method 700 also includes a step 704 of performing a signal analysis based on the output waveform signal to determine whether or not a motion event has occurred within the detection field of view of the PIR detector over an analysis period (e.g., equal to one second, if a new output waveform signal is supplied every second). More detail regarding the signal analysis step 704 will be provided below.

The signal analysis step 704 can include an initial step 706 of selecting between a lower sensitivity level (basic analysis) and a higher sensitivity level (in-depth analysis) for use in the signal analysis. Depending on the application, the sensitivity level can be selected by a user, with or without input from a processor, or by automatically by processor (i.e., without user intervention). As can be appreciated, the selection of the sensitivity level can be made based on various factors. Non-limiting examples of such factors can include power level conditions and environmental conditions.

First, if the lower sensitivity level is selected, the signal analysis step 704 can include a step 708 of comparing an amplitude parameter of the output waveform signal against an amplitude threshold, and determining that a motion event has occurred or not, based on whether or not the amplitude parameter matches or exceeds the amplitude threshold. That is, if the amplitude of the output waveform signal is equal to or greater than the amplitude threshold, an occurrence of a motion event is detected. On the contrary, if the amplitude is less than the amplitude threshold, no occurrence of a motion event is detected. In some implementations, if the amplitude of the output waveform signal is equal to or greater than the amplitude threshold at any time, even briefly, over its duration (i.e., the analysis period), a determination that a motion event has occurred can be made. However, in other implementations, more stringent thresholding criteria may be used. In an embodiment, the amplitude threshold can be equal to about 80% of a maximum amplitude value associated with the output waveform signal. For example, the maximum amplitude value can be the maximum output voltage of the PIR detector used to generate the output waveform signal. As can be appreciated, in another embodiment, the amplitude threshold can be set to a value different than 80%. Furthermore, in other embodiments, other waveform parameters of the output waveform signal can be used in addition or instead of an amplitude parameter.

In response to a determination that a motion event has occurred, the method 700 includes a step 710 of controlling or triggering a camera or an image capture device to initiate performing an image capture of the monitored scene. This step can be performed as previously described. On the contrary, in response to a determination that object motion has not occurred, the method 700 may or may not, as the case may be, return to the step 702 of receiving an output waveform signal to continue monitoring the scene for object motion.

Second, if the higher sensitivity level is selected, the signal analysis step 704 can include a step 712 of comparing an amplitude parameter of the output waveform signal against an amplitude threshold to make an initial assessment of whether a motion event has occurred or not. This step can be performed similarly to the corresponding step 708 described above and performed when the lower sensitivity level is selected. For example, in an embodiment, the amplitude threshold can be expressed in terms of a maximum amplitude value associated with the output waveform signal (e.g., 80% of the maximum amplitude value), or in terms of another criterion, as the case may be. As in the low-sensitivity case, other waveform parameters of the output waveform signal can be used in addition or instead of an amplitude parameter.

Then, depending on whether the initial assessment is positive (i.e., detection of object motion) or not (no detection of object motion), the signal analysis step 704 can include steps 714, 716 of comparing the output waveform signal against either a first or a second reference waveform signal make a further assessment of whether a motion event has occurred or not, wherein the first reference waveform signal has a smaller amplitude than the second reference waveform signal. The first and second reference waveform signals can be provided and obtained as previously described. In an embodiment, the waveform parameters that are used in the comparison between the output waveform signal and the first and second reference waveform signals are the amplitude and the period of the output waveform signal. As can be appreciated, in other embodiments, only one or neither of the amplitude and the period can be used in either of the comparison steps 714, 716. Non-limiting examples of other possible waveform parameters that can be used in addition to or instead of the amplitude and the period are provided above.

More specifically, if the initial assessment if positive (detection of object motion), the output waveform signal is compared, at step 714, to the first reference waveform signal to make a further assessment as to whether the output waveform signal matches the second reference waveform signal. If the further assessment is positive, corresponding to a determination that a motion event has occurred (and a confirmation of the initial assessment), the method 700 goes to the step 710 of controlling or triggering a camera or an image capture device to initiate performing an image capture of the monitored scene. If the further assessment is negative, corresponding to a determination that a motion event has not occurred (and a reversal of the initial assessment), the method 700 may or may not, as the case may be, return to the step 702 of receiving an output waveform signal to continue monitoring the scene for object motion.

In contrast, if the initial assessment if negative (no detection of object motion), the output waveform signal is compared, at step 716, to the second reference waveform signal to make a further assessment as to whether the output waveform signal matches the second reference waveform signal. If the further assessment is positive, corresponding to a determination that a motion event has occurred (and a reversal of the initial assessment), the method 700 goes to the step 710 of controlling or triggering a camera or an image capture device to initiate performing an image capture of the monitored scene. If the further assessment is negative, corresponding to a determination that a motion event has not occurred (and a confirmation of the initial assessment), the method 700 may or may not, as the case may be, return to the step 702 of receiving an output waveform signal to continue monitoring the scene for object motion.

As noted above, in the illustrated embodiment, the first reference waveform signal has a smaller amplitude than the second reference waveform signal. The reason for this is to give some weight to the initial assessment, making it more difficult to reverse it than to confirm it when performing the further assessment. Indeed, as can be appreciated, if the first reference waveform signal has a smaller amplitude than the second reference waveform signal, and assuming that an amplitude-based threshold detection criterion is used to assess object motion, then the likelihood that the further assessment be positive with the first reference waveform signal (corresponding to a confirmation of the positive initial assessment) is higher than the likelihood that the further assessment be positive with the second reference waveform signal (corresponding to a reversal of the negative initial assessment).

It should be noted that some implementations may omit the step of selecting a sensitivity level with which to perform the signal analysis. In such implementations, the signal analysis may be performed according to either a basis analysis mode (lower sensitivity level) or an in-depth analysis mode (higher sensitivity level), such as described above, but without the possibility of selecting between the two modes.

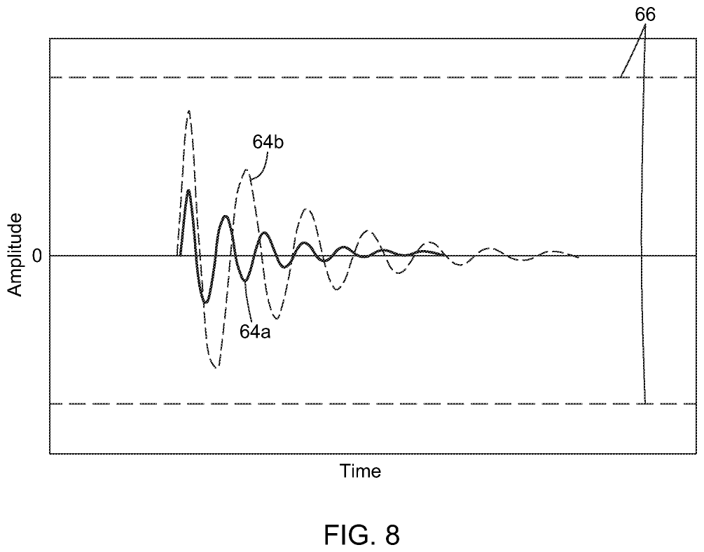

Referring to FIG. 8, in an embodiment, the first reference waveform signal 64a (solid line) is a waveform signal having an amplitude and a period of about 50% of the maximum amplitude 66 (in absolute value; dashed line) and period that can be measured by the PIR detector used to obtain the output waveform signal. Meanwhile, the second reference waveform signal 64b (dotted line) is a waveform signal having an amplitude and a period of about 80% of the maximum amplitude 66 and period that can be measured by the PIR detector used to obtain the output waveform signal. In an embodiment, the tolerance range for the determination of a match between the output waveform signal and the first reference waveform signal 64a or the second reference waveform signal 64b is a 10% variation between the amplitude and period of the output waveform signal and the amplitude and period of the corresponding one of the first reference waveform signal 64a or the second reference waveform signal 64b. Of course, other tolerance range values can be used in other embodiments.

As can be appreciated, either or both of the first reference waveform signal 64a and the second reference waveform signal 64b could differ from those illustrated in FIG. 8, for example to determine the occurrence of motion events corresponding to different subject types (e.g., different reference waveform signals corresponding to different animal types, animal categories, mammal types, and like). For example, in an embodiment, a plurality of reference waveform signals can be stored in a data source (e.g., a database) accessible by the control unit of a camera for comparison with the output waveform signal of a PIR detector of the camera and detection of object motion, where the reference waveform signals correspond to specific subject types or groups of subject types selected by the user.

### PIR Motion Sensing Device Implementations

Referring to FIGS. 9 to 11, in accordance with another aspect, there is provided a PIR motion sensing device 48 for detecting object motion within a monitored scene 16. The PIR motion sensing device 48 includes a PIR detector 50 configured to receive infrared radiation 26 from the monitored scene 16 within a detection field of view 18 and to generate an output waveform signal 52 indicative of time-dependent variations in the received infrared radiation 26 in response to a motion of an object 14 within the detection field of view 18. As noted above, the PIR detector 50 can include collection optics 55 (e.g., a Fresnel lens) and one or more PIR sensors 51 (e.g. pyroelectric sensors). The PIR motion sensing device 48 also includes a processor 36 configured to receive the output waveform signal 52 generated by the PIR detector 50 and perform a signal analysis based on the output waveform signal 52 to determine whether a motion event has occurred. The PIR motion sensing device 48 further includes a memory 47 operatively coupled to the processor 36.

As can be appreciated, the construction and operation of the PIR detector 50 and the processor 36 of the PIR motion sensing device 48 in FIGS. 9 to 11 can be similar to those of the PIR detector 50 and the processor 36 of the motion-detection-activated camera 10 in FIGS. 1 to 4. In fact, PIR detector 50 and the processor 36 of the motion-detection-activated camera 10 in FIGS. 1 to 4 can be said to define a PIR motion sensing device. However, while in some implementations the PIR motion sensing device 48 may be manufactured as a part of a motion-detection-activated camera 10 another device, in other embodiments the PIR motion sensing device 48 may be manufactured and sold as a separate integrated unit, which may be intended for use with, or as part of, a camera or another device.

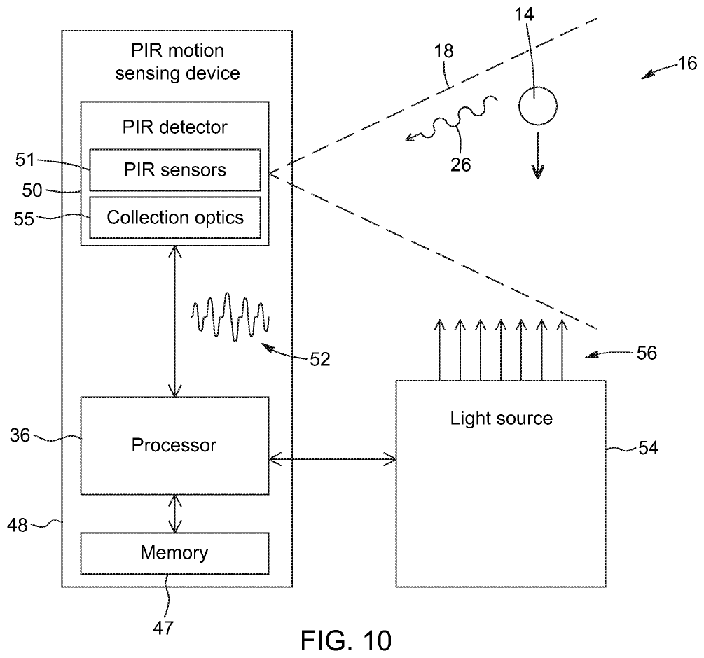

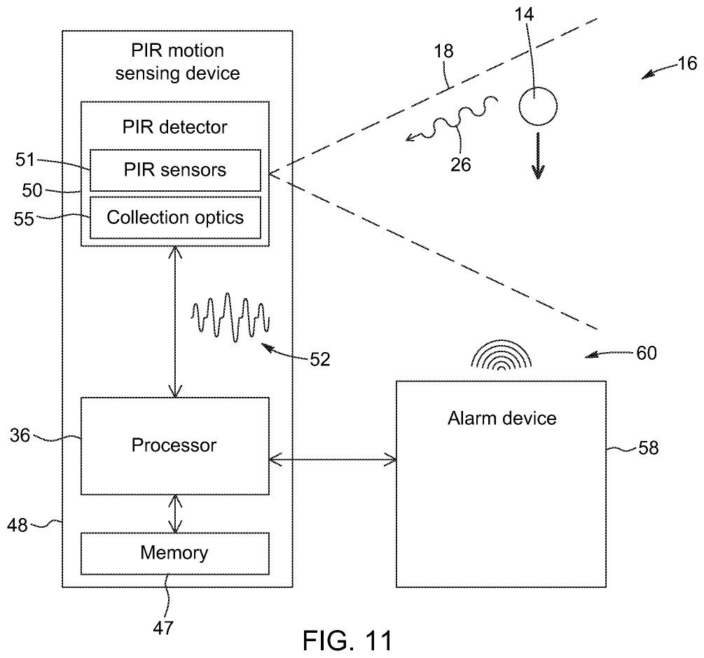

Referring to FIG. 9, upon determination that a motion event has occurred, the processor 36 of the PIR motion sensing device 48 can control an image sensor 42 of a camera or image capture device 10 to perform an image capture of the monitored scene 16 within an imaging field of view 38 of the image sensor 42 for acquiring one or more images of the moving object 14. However, in other implementations, other or further actions can be initiated by the processor 36 of the PIR motion sensing device 48 in response to a determination that a motion event has occurred. Non-limiting examples of such actions are described below with reference to FIGS. 10 and 11.

Referring to FIG. 10, in an embodiment, the PIR motion sensing device 48 is coupled to a light source 54. In this embodiment, upon determination that a motion event has occurred, the processor 36 of the PIR motion sensing device 48 is configured to initiate or control the light source to emit illumination light 56 to illuminate the monitored scene 16 or a portion thereof.

Referring to FIG. 11, in another embodiment, the PIR motion sensing device 48 is coupled to an alarm device 58. In this embodiment, upon determination that a motion event has occurred, the processor 36 of the PIR motion sensing device 48 is configured to initiate or control the alarm device 58 to generate an alarm signal 60. Depending on the application, the alarm signal 60 may be any or all of an audible signal, a visual signal, a vibrational signal, an electrical signal, or a wireless signal.

Of course, it will be appreciated that, in some implementations, the PIR motion sensing device as described herein may be used as standalone device configured for object motion detection, without coupling to another device configured to be activated to initiate some action by the PIR sensing motion device upon determination that a motion event has occurred.

### Computer Readable Medium and Computer Device Implementations

In accordance with another aspect of the present description, there is provided a non-transitory computer readable storage medium having stored thereon computer readable instructions that, when executed by a processor, cause the processor to perform a method for detecting object motion within a monitored scene, as described with reference to the figures.

In the present description, the terms “computer readable storage medium” and “computer readable memory” are intended to refer to a non-transitory and tangible computer product that can store and communicate executable instructions for the implementation of various steps of the methods disclosed herein. The computer readable memory can be any computer data storage device or assembly of such devices, including random-access memory (RAM), dynamic RAM, read-only memory (ROM), magnetic storage devices such as hard disk drives, solid state drives, floppy disks and magnetic tape, optical storage devices such as compact discs (CDs or CDROMs), digital video discs (DVD) and Blu-ray™ discs; flash drive memory, and/or other non-transitory memory technologies. A plurality of such storage devices may be provided, as can be understood by one skilled in the art. The computer readable memory may be associated with, coupled to, or included in a computer or processor configured to execute instructions contained in a computer program stored on or in the computer readable memory and relating to various functions associated with the computer.

In some implementations, the computer executable instructions stored on the computer readable storage medium can instruct a processor to perform one or more of the following steps: receiving, by the processor, an output waveform signal generated from infrared radiation received by an infrared detector from the monitored scene within a detection field of view, the output waveform signal being indicative of time-dependent variations in the received infrared radiation in response to object motion within the detection field of view; and performing, by the processor, a signal analysis based on the output waveform signal to determine that object motion has occurred.

In some implementations, the non-transitory computer readable storage medium having stored thereon computer executable instructions that, when executed by a processor, can cause the processor to various method steps described above relating to the performing of the signal analysis based on the output waveform signal.

In some implementations, the non-transitory computer readable storage medium having stored thereon computer executable instructions that, when executed by a processor, can cause the processor to activate the infrared detector to initiate receiving the infrared radiation from the monitored scene within the detection field of view.

In some implementations, the non-transitory computer readable storage medium having stored thereon computer executable instructions that, when executed by a processor, can cause the processor to take an action in response to the processor determining that a motion event has occurred. As noted above, the action taken can include triggering, by the processor, an image sensor to capture an image, a light source or lighting device to emit illumination light, an alarm to generate an alarm signal, or a combination thereof.

In accordance with another aspect of the present description, there is provided a computer device including a processor and non-transitory computer readable storage medium having stored thereon computer readable instructions that, when executed by a processor, cause the processor to perform various steps of the methods for object motion detection disclosed herein. FIG. 3 depicts an example of a computer device 40 including a processor 36 and a non-transitory computer readable storage medium 47 operably connected to the processor 36.

Various embodiments and examples have been described and illustrated herein. The embodiments and examples described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein, unless stated otherwise. It is understood that the present techniques may be embodied in other specific forms without departing from the central characteristics thereof. The present examples and embodiments, therefore, are to be considered in all respects as illustrative and not restrictive, and the present description is not to be limited to the details given herein. Accordingly, while specific embodiments have been illustrated and described, numerous modifications come to mind without significantly departing from the scope of the appended claims.

1. An infrared motion sensing device for detecting object motion within a monitored scene, the infrared motion sensing device comprising:
an infrared detector configured to receive infrared radiation from the monitored scene within a detection field of view and to generate an output waveform signal indicative of time-dependent variations in the received infrared radiation in response to object motion within the detection field of view; and
a processor configured to receive the output waveform signal generated by the infrared detector and perform a signal analysis based on the output waveform signal to determine whether a motion event has occurred.

2. The infrared motion sensing device of claim 1, wherein the infrared detector comprises:
one or more infrared sensors; and
collection optics optically coupled to the one or more infrared sensors to define the detection field of view, the collection optics being configured to collect the infrared radiation received from within the detection field of view and direct it to the one or more infrared sensors.

3. The infrared motion sensing device of claim 2, wherein the one or more infrared sensors comprise a pair of passive infrared (PIR) pyroelectric sensors configured to produce electrical outputs of opposite polarities in response to infrared radiation exposure.

4. The infrared motion sensing device of claim 2, wherein the collection optics comprises a Fresnel lens configured to create a plurality of detection zones within the detection field of view.

5. The infrared motion sensing device of claim 1, wherein the processor is configured to perform the signal analysis by assessing one or more waveform characteristics of the output waveform signal over an analysis period.

6. The infrared motion sensing device of claim 1, further comprising a memory operatively coupled to the processor, wherein the memory is configured to store thereon one or more reference waveform signals, and wherein the processor is configured to determine that a motion event has occurred by finding a match between the output waveform signal and the one or more reference waveform signals.

7. The infrared motion sensing device of claim 1, wherein the processor is configured to perform the signal analysis by:
selecting between a lower sensitivity level and a higher sensitivity level for use in the signal analysis;
if the lower sensitivity level is selected, comparing an amplitude parameter of the output waveform signal against an amplitude threshold, and determining that a motion event has occurred or not, based on whether or not the amplitude parameter matches or exceeds the amplitude threshold; and
if the higher sensitivity level is selected, comparing an amplitude parameter of the output waveform signal against an amplitude threshold to make an initial assessment of whether a motion event has occurred or not, and depending on whether the initial assessment is positive or not, comparing the output waveform signal against either a first or a second reference waveform signal to make a further assessment of whether a motion event has occurred or not, wherein the first reference waveform signal has a smaller amplitude than the second reference waveform signal.

8. The infrared motion sensing device of claim 1, wherein the processor is configured to activate an output device in response to the processor determining that a motion event has occurred.

9. A method for detecting object motion within a monitored scene, the method comprising:
receiving radiation from the monitored scene within a detection field of view;
generating, by a processor, an output waveform signal indicative of time-dependent variations in the received radiation in response to object motion within the detection field of view; and
performing, by the processor, a signal analysis based on the output waveform signal to determine whether a motion event has occurred.

10. The method of claim 9, wherein performing the signal analysis comprises assessing one or more waveform characteristics of the output waveform signal over an analysis period.

11. The method of claim 10, wherein the one or more waveform characteristics include an amplitude, a period, or a combination thereof.

12. The method of claim 9, wherein performing the signal analysis comprises:
providing one or more reference waveform signals; and
determining that a motion event has occurred by finding a match between the output waveform signal and the one or more reference waveform signals.

13. The method of claim 9, wherein performing the signal analysis comprises:
selecting between a lower sensitivity level and a higher sensitivity level for use in the signal analysis;
if the lower sensitivity level is selected, comparing an amplitude parameter of the output waveform signal against an amplitude threshold, and determining that a motion event has occurred or not, based on whether or not the amplitude parameter matches or exceeds the amplitude threshold; and
if the higher sensitivity level is selected, comparing an amplitude parameter of the output waveform signal against an amplitude threshold to make an initial assessment of whether a motion event has occurred or not, and depending on whether the initial assessment is positive or not, comparing the output waveform signal against either a first or a second reference waveform signal to make a further assessment of whether a motion event has occurred or not, wherein the first reference waveform signal has a smaller amplitude than the second reference waveform signal.

14. The method of claim 9, wherein performing the signal analysis comprises determining one or more of object position information, object speed information, object direction of travel information, object size information, object shape information, and object type information about the motion event.

15. The method of claim 9, further comprising, in response to determining that a motion event has occurred, activating, by the processor, an image sensor, a light source, an alarm, or a combination thereof.

16. The method of claim 9, wherein the radiation received from the scene comprises infrared radiation.

17. A non-transitory computer readable storage medium having stored thereon computer readable instructions that, when executed by a processor, cause the processor to perform a method for detecting object motion within a monitored scene, the method comprising:
receiving, by the processor, an output waveform signal generated from infrared radiation received by an infrared detector from the monitored scene within a detection field of view, the output waveform signal being indicative of time-dependent variations in the received infrared radiation in response to object motion within the detection field of view; and
performing, by the processor, a signal analysis based on the output waveform signal to determine that object motion has occurred.

18. The non-transitory computer readable storage medium of claim 17, wherein the method further comprises activating, by the processor, the infrared detector to initiate receiving the infrared radiation from the monitored scene within the detection field of view.

19. The non-transitory computer readable storage medium of claim 17, wherein performing the signal analysis comprises:
providing one or more reference waveform signals; and
determining that a motion event has occurred by finding a match between the output waveform signal and the one or more reference waveform signals.

20. The non-transitory computer readable storage medium of claim 17, wherein performing the signal analysis comprises:
selecting between a lower sensitivity level and a higher sensitivity level for use in the signal analysis;
if the lower sensitivity level is selected, comparing an amplitude parameter of the output waveform signal against an amplitude threshold, and determining that a motion event has occurred or not, based on whether or not the amplitude parameter matches or exceeds the amplitude threshold; and
if the higher sensitivity level is selected, comparing an amplitude parameter of the output waveform signal against an amplitude threshold to make an initial assessment of whether a motion event has occurred or not, and depending on whether the initial assessment is positive or not, comparing the output waveform signal against either a first or a second reference waveform signal to make a further assessment of whether a motion event has occurred or not, wherein the first reference waveform signal has a smaller amplitude than the second reference waveform signal.

21. The non-transitory computer readable storage medium of claim 17, wherein the method further comprises taking an action in response to the processor determining that a motion event has occurred.

22. The non-transitory computer readable storage medium of claim 21, wherein taking an action comprises triggering, by the processor, an image sensor to capture an image, a light source to emit illumination light, an alarm to generate an alarm signal, or a combination thereof.

23. A computer device for detecting object motion within a monitored scene, the computer device comprising a processor; and the non-transitory computer readable storage medium of claim 17, the non-transitory computer readable storage medium being operatively coupled to the processor.

24. A motion-detection-activated camera comprising:
an image sensor for imaging a target area;
an infrared detector configured to monitor the target area for object motion, the infrared detector receiving infrared radiation from the target area and generating an output waveform signal indicative of time-dependent variations in the received infrared radiation in response to motion of an object within the target area; and
a processor operatively connected to the image sensor and the infrared detector, the processor being configured to receive the output waveform signal generated by the infrared detector, perform a signal analysis based on the output waveform signal to determine that object motion has occurred, and, in response to determining that object motion has occurred, control the image sensor to capture one or more images of the target area.

25. The motion-detection-activated camera of claim 24, wherein the infrared detector comprises:
one or more passive infrared (PIR) pyroelectric sensors configured to sense the received infrared radiation and convert the received infrared radiation to yield the output waveform signal; and
a Fresnel lens configured to collect the infrared radiation from the target area and to direct it to the one or more PIR pyroelectric sensors.

26. The motion-detection-activated camera of claim 25, wherein the one or more PIR pyroelectric sensors comprise a pair of PIR pyroelectric sensors configured to produce electrical outputs of opposite polarities in response to infrared radiation exposure.

27. The motion-detection-activated camera of claim 24, wherein the processor is configured to perform the signal analysis by assessing one or more waveform characteristics of the output waveform signal.

28. The motion-detection-activated camera of claim 24, further comprising a memory operatively coupled to the processor, wherein the memory is configured to store thereon one or more reference waveform signals, and wherein the processor is configured to determine that a motion event has occurred by finding a match between the output waveform signal and the one or more reference waveform signals.
